(19) United States
(12) Patent Application Publication
(10) Pub. No.: US 2025/0257693 A1
(43) Pub. Date: Aug. 14, 2025

(54) VALVE UNIT FOR CONTROLLING THE FUEL FEED IN A FUEL SUPPLY SYSTEM, IN PARTICULAR OF AN AIRCRAFT

(71) Applicant: Rolls-Royce Deutschland Ltd & Co KG, Blankenfelde-Mahlow (DE)

(72) Inventors: Gregor Christoffer GEBEL, Ludwigsfelde (DE); Carsten CLEMEN, Mittenwalde (DE)

(21) Appl. No.: 19/046,983

(22) Filed: Feb. 6, 2025

(30) Foreign Application Priority Data
Feb. 14, 2024 (DE) 102024201358.7

(51) Int. Cl. F02C 7/232

(52) U.S. Cl. CPC F02C 7/232; F05D 2220/323

(57) ABSTRACT

A valve unit includes a in a housing which is subdivided, by an adjustable obturator in a fluid-tight manner in the valve space into first and second chambers separated from one another and through which fuel flows. The valve space has a first inlet for main fuel, a second inlet for pilot fuel, a first outlet for supplying fuel to an engine main stage, and a second outlet, for supplying fuel to an engine pilot stage. An elastic restoring element interacting with a fuel pressure difference between the chambers supplies an adjustment force, for positioning the obturator such that the obturator is adjustable into a closing position blocking the second outlet. The second chamber includes a further inlet for feeding a further fuel portion and a further outlet for discharging fuel from the second chamber and which remains open when the obturator is in the closing position.

The invention relates to a valve unit unit having an, in particular cylindrical, valve space which is arranged in a housing and which is subdivided, by means of an obturator arranged adjustably and in a fluid-tight manner in the valve space, into two chambers, a first chamber and a second chamber, that are separated from one another in a fluid-tight manner and through which fuel flows or is able to flow, wherein the valve space has a first inlet for feeding a first fuel portion, in particular main fuel, and a second inlet for feeding a second fuel portion, in particular pilot fuel, the valve space has a first outlet, in particular for supplying fuel to an engine main stage, and a second outlet, in particular for supplying fuel to an engine pilot stage, and the valve unit has an elastic restoring element, in particular a spring arrangement, which is arranged in one of the chambers, in particular in the second chamber and is coupled in a force-transmitting manner to the obturator, and the valve unit is configured such that an adjustment force for positioning the obturator within the valve space is generated by a restoring force of the restoring element interacting with a pressure difference between the chambers, wherein the pressure difference results between the fuel pressures within the chambers, with the result that the obturator is adjustable into a closing position blocking the second outlet.

A valve unit for controlling the fuel feed for an engine, in particular a gas turbine arrangement of an aircraft of this type is disclosed in the applicant's German Patent Application No. 10 2023 203 281.3, which is not a prior publication. The valve unit has a valve space, surrounded by a housing, having a first and a second inlet and a first and a second outlet, wherein, in the valve space, an obturator is arranged in a displaceable manner, which subdivides the valve space into a first and a second chamber through which fuel flows or is able to flow. The valve unit is incorporated into the fuel supply system and configured such that a first fuel portion, in particular main fuel, is fed via the first inlet and a second fuel portion, in particular pilot fuel, is fed via the second inlet, and fuel is supplied in particular to an engine main stage or to the main stage of a fuel nozzle of a gas turbine combustion chamber via the first outlet, and fuel is supplied to an engine pilot stage or pilot stage of the fuel nozzle via the second outlet. A restoring element, in particular a spring, coupled to the obturator in a force-transmitting manner is arranged in one of the chambers, in particular the second chamber. An adjustment force for positioning the obturator within the valve space is generated by the restoring force of the restoring element interacting with a pressure difference between the two chambers, wherein the pressure difference results between the fuel pressures within the chambers. Tests by the inventors have revealed that the closing of the pilot stage also immediately prevents fuel from flowing into the chamber responsible for feeding the pilot stage, and this is attributed to an inevitable effect in incompressible, liquid fuels. As a result, the pressure difference between the first and the second chamber, the pilot and main chamber, at higher operating points cannot increase further, and so the movable cylinder remains in a metastable and poorly predictable position. During operation, it is therefore possible for pressure fluctuations between the pilot and main chamber to result in the cylinder moving back and forth precisely at the position at which the second outlet or pilot outlet is closed. As a result, the outlet can repeatedly open, with the result that fuel is briefly passed to the pilot stage. This prevents quiet, low-emission and readily predictable operation of the combustion chamber.

A further valve unit for controlling the fuel feed for a gas turbine arrangement of an aircraft is disclosed in US 11 215 121 B2. Therein, at least one first inlet and outlet for feeding a first fuel portion or main fuel to a nozzle arrangement and at least one second inlet and outlet for feeding a second fuel portion or pilot fuel to the nozzle arrangement are provided in a housing with a cylindrical valve space, in order to generate a defined fuel/air mixture for combustion and the operation of a gas turbine arrangement. Therein, the second or pilot outlet and the second or pilot inlet are positioned diametrically opposite one another in the housing. To drive an obturator arranged displaceably in the valve space, provision is made, for example, for fuel to be pressurized via an electrically or hydraulically operated pump, in order to generate, at one end of the valve space, a servo flow which counteracts the spring force of a spring arranged at the other end of the valve space.

Further valve units in conjunction with a gas turbine arrangement are disclosed in US 6 058 694 A, in that case for controlling a lubricant feed, and in US 11 230 980 B2.

DE 10 2011 082 645 A1 discloses a valve unit in a low-pressure circuit for a fuel injection system, in particular a common rail injection system, comprising a fuel tank and a pre-feed pump, by means of which fuel is able to be drawn out of the fuel tank and is able to be fed to a high-pressure pump via a fuel line. The valve unit, which is in the form of a 2/2-way valve, is arranged in the fuel line and establishes, in the open position, a hydraulic connection of an engine space with a pump working space of the high-pressure pump and allows, in the closed position, zero feed operation. The 2/2-way valve has a displaceable valve element, which delimits, with a first end face, a control space which is supplied with fuel via a further line that branches off from the fuel line. The second end face, remote from the control space, of the displaceable valve element is subjected to the pressure force of a spring which is accommodated in a spring space. The spring space is attached to the fuel tank in order to discharge a leakage amount via a return line. The return pressure substantially prevails in the spring space. The two chambers of the valve space that are separated from one another by the obturator, and the inlets and outlets present at the valve space are not incorporated into a fuel supply system such that fuel is fed to a fuel nozzle for use in a gas turbine combustion chamber.

The present invention is based on the object of providing a valve unit for supplying a combustion chamber with fuel via a fuel supply system, which, while having as little complexity as possible in terms of parts, results in functioning of the fuel supply system that is reliable as possible. Furthermore, a fuel supply system constructed with such a valve unit, and a gas turbine arrangement equipped therewith are intended to be specified.

According to the invention, this object is achieved in the case of a valve unit by the features of claim 1, and in the case of a fuel supply system by the features of claim 20 and in the case of a gas turbine arrangement by the features of claim 22.

In the case of the valve unit, in conjunction with the features in the preamble, the invention also provides that the second chamber is provided with a further inlet for feeding a further fuel portion and with a further outlet, via which fuel is able to be discharged from the second chamber and which remains open when the obturator is in the closing position closing the second outlet.

Fuel provided from a manifold via a pre-chamber (distribution chamber) enters the valve space via three lines, the cylinder feeds with the second and the further input to the second chamber, in particular pilot chamber, with a pressure loss DPP=P0−PP, which is generated, for example, via a pressure-regulating means (restrictor), and via a cylinder feed with the first input to the first chamber (main chamber), with a pressure loss DPH=P0-PH, likewise set, for example, via a pressure-regulating means (restrictor). In this case, the pressure loss on entering the valve space on the side of the second chamber or pilot chamber is greater than that on the side of the first chamber or main chamber, wherein pressure-regulating means that are used are appropriately designed: DPP>DPH results in PP<PH. The individual pressure PH or PP prevailing in the first and the second chamber (main chamber and pilot chamber) is reduced compared with the pressure P0 prevailing in the manifold, as a result of the conditions prevailing in the respective feeds, in particular integrated pressure-regulating means. Thus, PP<PH. The fuel can exit the two chambers through the outlets-the first, the second and the further outlet-and thus supply the fuel nozzle with fuel.

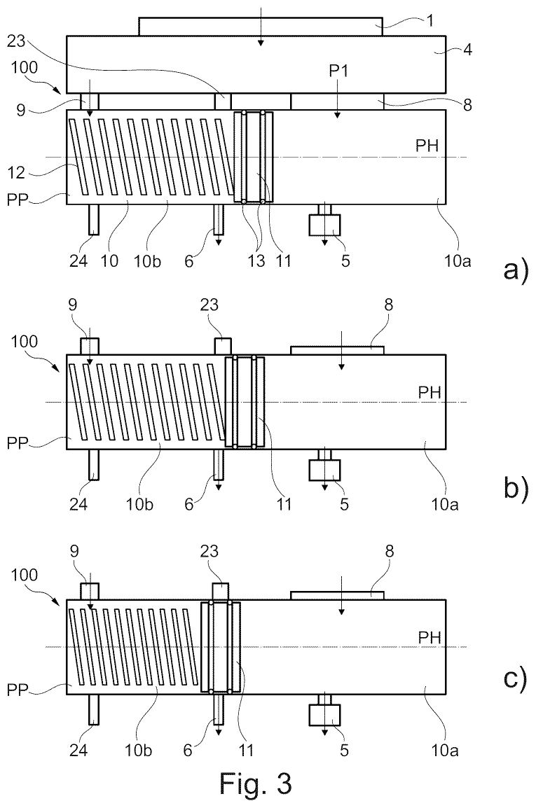

The basic manner of functioning of the valve unit designed in this way is explained in principle in more detail below with reference to FIGS. 3a) to c). By means of the abovementioned measures, it is largely possible for a sudden change in the pressure in the second chamber or pilot chamber to be almost completely avoided, given appropriate dimensioning of the feed line to the relevant inlet of the second chamber, with the optionally present pressure-regulating means and the drain at the further outlet of the second chamber. This substantially contributes to quiet, low-emission and readily predictable operation of the combustion chamber.

An advantageous configuration of the valve unit in coordination with the fuel supply system consists in that the further outlet is designed to supply the engine main stage with fuel, in particular by connection to the first outlet in the downstream region thereof. If the second outlet of the second chamber is closed, fuel entering via the relevant inlet of the second chamber and the optionally associated pressure-regulating means is fed via the further outlet to the engine main stage and thus a sudden change in the pressure in the second chamber is counteracted. In particular, a sudden change in the pressure is avoided when the relevant feed line to the second chamber and the drain via the further outlet are dimensioned such that, with omission (or addition) of the other mass flow path (in particular via the feed line to the further inlet of the second chamber) in the relevant outlet (in particular the second outlet of the second chamber), a sudden change in the pressure in the second chamber does not occur.

Reliable functioning of the valve unit is achieved in that the further inlet is arranged at the second chamber axially in a corresponding position to the second outlet, such that it is likewise blocked by the obturator when the latter is in the closing position closing the second outlet. The second inlet is offset axially with respect to the second outlet in the direction of the fixed end of the valve space on the side of the second chamber, wherein the second inlet and the second outlet advantageously (but not necessarily) lie diametrically opposite one another.

For precisely coordinating the pressure ratios in the valve space, or the first and second chamber, and for reliable and precise functioning, the invention advantageously provides that the valve unit is assigned at least one pressure-regulating means which, to set a pressure ratio between the first chamber and the second chamber, is arranged preferably upstream of the valve space in order to generate a defined fuel ratio between the first fuel portion and second fuel portion, wherein preferably a lower pressure is generated or able to be generated in the second chamber than in the first chamber.

Advantageous coordination of the pressure ratios can be achieved in that both the first inlet and the second inlet and/or further inlet are assigned a pressure-regulating means, wherein, in the event that the second inlet and the further inlet are assigned a pressure-regulating means, either the second inlet and the further inlet are each assigned a pressure-regulating means or both of these inlets are assigned a common pressure- regulating means via a Y-connection.

A simple configuration that is not very prone to failure consists in that the at least one pressure-regulating means is in the form of a passive flow element that is not adjustable during operation, in particular having a narrowing of the flow cross section.

For reliable functioning in regular operation and/or in the case of failure, or for reliable failure protection, a further advantageous configuration consists in that the valve unit can take up a regular configuration and/or an error configuration, wherein
in the regular configuration, the obturator is arranged within the valve space such that, during operation in a first adjustment mode, the first inlet, and not the second inlet, is fluidically connected to the first outlet by the first chamber, and/or such that the second inlet and the further inlet, and not the first inlet, are fluidically connected to the second outlet and the further outlet by the second chamber, and in a second adjustment mode, at least the second outlet is blocked in a manner preventing flow-through by means of the obturator, such that flow does not take place through the second outlet, but flow continues to take place through the second chamber via the further outlet, and/or
in the error configuration, the obturator is arranged next to the outlets within the valve space such that, during operation, the first and the second outlet are fluidically connected to at least the same inlet for fuel supply, and the further outlet is fluidically connected at least to the second inlet.

Advantageous provisions for reliable operation of a gas turbine, in particular in an aircraft engine, consist in that the restoring element is designed such that, in the regular configuration, the first adjustment mode is set without a pressure difference, for example with the engine switched off, and/or with a small pressure difference between the chambers, for example in a low-load range of an engine, and/or the second adjustment mode is set with a greater pressure difference than the small pressure difference, for example in a medium- and/or high-load range.

At low load, for example on starting an engine or when the engine is idling, the supply with the pilot fuel is ensured, while at high load, for example when cruising or in a starting phase, a pilot fuel supply is switched off.

In the case of failure, the invention advantageously provides that in the error configuration, in a first error position, the obturator is positioned further in the direction of the restoring element compared with the regular configuration, in particular with a reduction in size of the second chamber. This error position is adopted in the case of failure of the spring, in particular if the spring force is lost or if the spring is completely compressed.

Reliable functioning in the case of failure is also achieved in that in the error configuration, in a second error position, the obturator is positioned further in the direction of an opposite end of the valve space from the restoring element compared with the regular configuration, in particular with a reduction in size of the first chamber, such that the first inlet is fluidically connected to the second chamber. Such failure occurs in particular if the spring breaks and a pressure difference with regard to the two end faces of the obturator (i.e. the side thereof facing the first chamber and the second chamber) is zero, or if the engine is switched off. The obturator is then capable of free movement, in this case with the first chamber being reduced in size.

Thus, in the abovementioned configuration, the error configuration or the emergency scenario ensures that the pilot supply with fuel is ensured from idling up to high-load operation. Idling means in the present case the speed at which, although the engine is rotating independently, it does not generate any or generates hardly any thrust.

A configuration of the valve unit that is advantageous for the structure and functioning consists in that the valve space is formed in an elongate, in particular cylindrical, manner and/or has, along its length, a constant cross section or portions with different cross sections, wherein the cross section is constant within the portions, and in that the obturator is arranged in the valve space so as to be axially displaceable in the longitudinal direction, wherein the obturator has in particular a corresponding cross section to the valve space in order to be in fluid-tight contact with the inner walls of the valve space, preferably with at least one sealing means arranged in between.

For precise functioning of the valve unit and for further safety measures, the invention also advantageously provides that a collecting chamber for receiving fragments of elements present in the valve space, in particular of the obturator and/or of the restoring element, is arranged next to the valve space, in particular next to the chamber that does not contain the restoring element, wherein a holding element, in particular a magnet, is arranged in the collecting chamber.

A contributory factor to improved functioning of the restoring element and precise positioning of the obturator is that, in addition to the restoring element, a second elastic element, in particular a support spring, is arranged on the side of the restoring element, said second elastic element being shorter than the restoring element and being designed to cooperate with the restoring element, in particular under high-load conditions, and having, for example, lower elasticity than the restoring element in order to support the restoring force thereof, or in that a spring having a restoring force that is not linear along its spring travel is used as restoring element.

A contributory factor to defined positioning of the obturator is that within the valve space, in particular in the first chamber, at least one stop element is arranged, which limits the movement of the obturator by the restoring element at a zero position.

An advantageous configuration for precise functioning and exact setting of the obturator and a compact, short structure is that the valve space has portions with different cross sections, wherein, in the valve space, a first additional chamber with a smaller cross section adjoining the first chamber in an axial direction is formed on the side of the first chamber and/or a second additional chamber of smaller cross section adjoining in the opposite axial direction is formed on the side of the second chamber, and that the obturator, which is displaceable in the valve space, has portions with a thicker and a thinner cross section corresponding to the first and second chamber and to the first and/or second additional chamber.

Advantageous further measures for functioning are that when the first and second additional chamber exist, the relevant first and second inlet are arranged at the respective additional chamber and the further inlet is arranged at the second chamber, the first outlet is arranged at the first additional chamber, and the second outlet is arranged at the second chamber and the further outlet is arranged at the second additional chamber, and that in a configuration without the first additional chamber, the first inlet and the first outlet are arranged at the first chamber, the second inlet is arranged at the second additional chamber, the further inlet is arranged at the second chamber, the second outlet is arranged at the second chamber and the further outlet is arranged at the second additional chamber.

Other contributory factors to precise, reliable functioning are the measures that, parallel to the valve space, there is at least one bypass line, which is/are arranged such that, with particular positions of the obturator in the valve space, the two end faces of the thicker portion are subject to the same pressure on both sides.

The structure and functioning are also promoted by virtue of the fact that when the first additional chamber and the corresponding portion of thinner cross section of the obturator exist, a channel arrangement is formed in this portion in order to fluidically connect an inlet region of the first additional chamber to the first chamber via the associated bypass line.

Further advantageous measures for functioning and precise control of the fuel flow consist in that at least one of the transitions from the valve space into the first or the second outlet is narrowed in a funnel shape towards an adjoining line portion, or has a cross section that influences the division of the fuel flow between the pilot fuel and the main fuel in a defined manner.

Advantages in the fuel feed are also achieved by a fuel supply system for supplying a gas turbine arrangement, in particular of an aircraft, with fuel, comprising a valve unit according to any of claims 1 to 19.

For an advantageous feed of the fuel to a combustion chamber arrangement, a fuel supply system is advantageous which is characterized in that an individual valve unit for supplying a plurality of main stages and/or pilot stages with fuel is formed, wherein, downstream of the valve unit, a branch portion is arranged in a main line and/or in a pilot line, optionally in each.

Advantageous operation also arises in the case of a gas turbine arrangement having a combustion chamber arrangement and a fuel supply system comprising at least one valve unit according to any of claims 1 to 19 and a turbine arrangement.

Further advantages are achieved in the case of a method for operating a fuel supply system of a gas turbine arrangement, in particular of an engine for an aircraft, in which a valve unit according to any of claims 1 to 19 is used.

The invention will be explained in more detail in the following text by way of exemplary embodiments with reference to the drawings, in which:

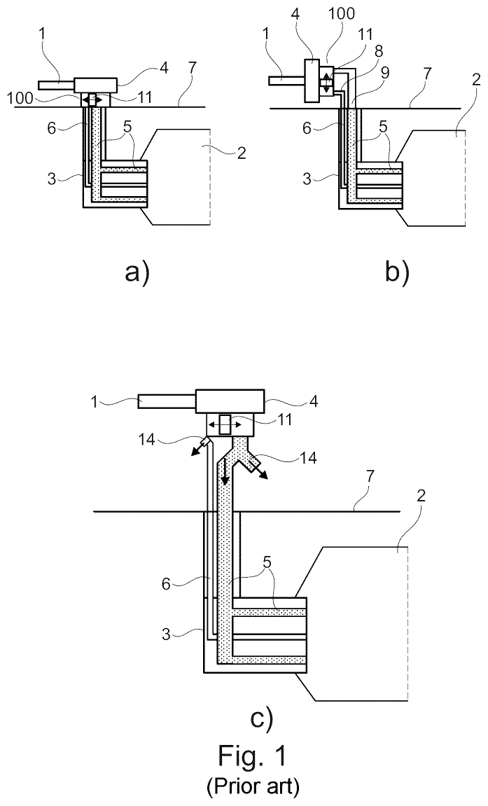

FIG. 1 shows, in sub-figures a), b) and c), a schematic illustration of a detail of a fuel supply system having a fuel feed, which is connected to a manifold and a pre-chamber (distribution chamber) and has a valve unit, to a fuel nozzle which is connected to a combustion chamber located in a combustion chamber housing, in various arrangement variants according to the prior art,

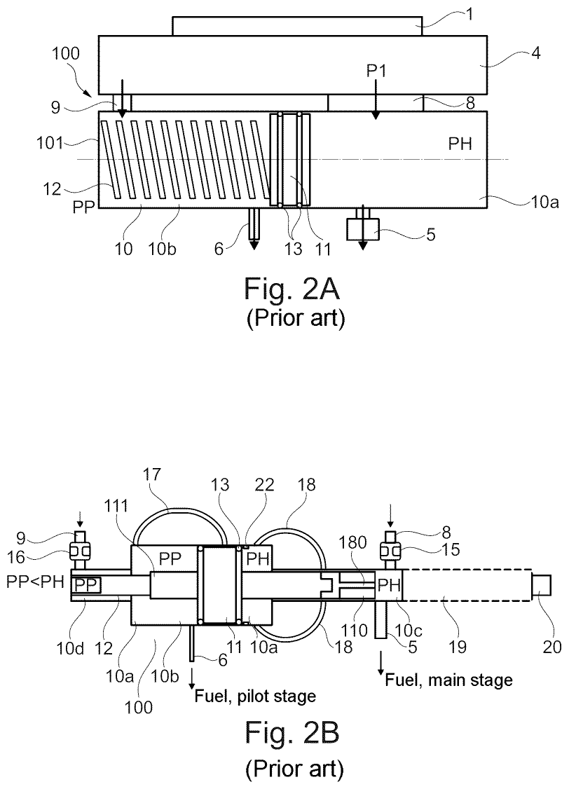

FIG. 2A shows a schematic illustration of a valve unit, which is connected to a manifold via a pre-chamber, for feeding fuel to a fuel nozzle according to the prior art,

FIG. 2B shows a schematic illustration of an exemplary embodiment of a valve unit, provided with inlets and outlets for the fuel supply, according to the prior art,

FIG. 3 shows, in sub-figures a), b) and c), a schematic illustration of the basic functioning, which exists upon incorporation into a fuel feed to a fuel nozzle, of a valve unit in a configuration according to the invention in three different pressure states, for example in different operating states of an engine,

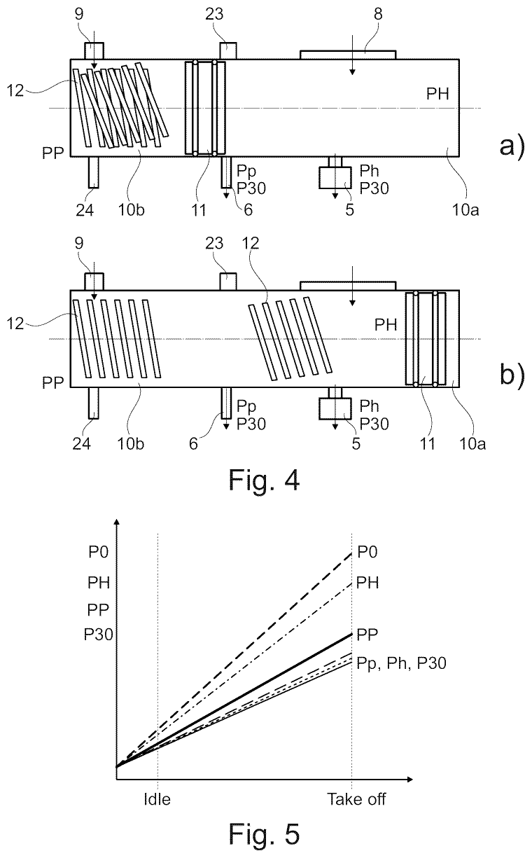

FIG. 4 shows, in sub-figures a) and b), a schematic illustration of a valve unit according to FIG. 3 in two different cases of failure of a restoring element in the form of a spring of the valve unit,

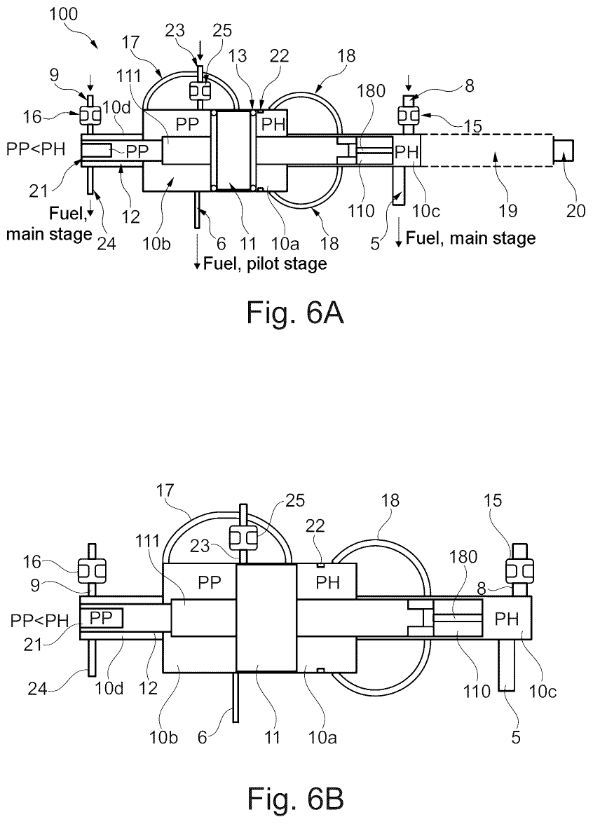

FIG. 5 shows a schematic illustration of a diagram showing the progression of different pressures in the region of the valve unit depending on operating states of an engine,

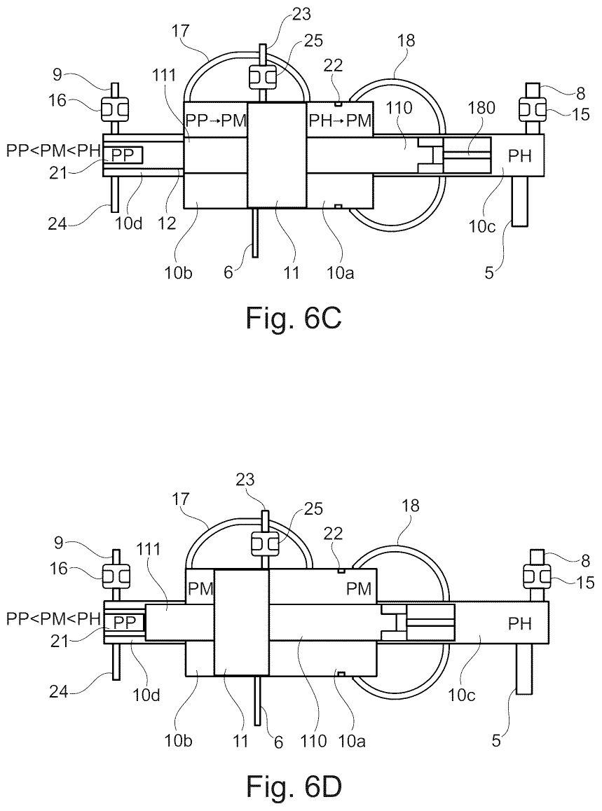

FIGS. 6A to 6G show a schematic illustration of a configuration variant of a valve unit according to the invention in different operating states with detailed reproduction of valve components that are essential to functioning,

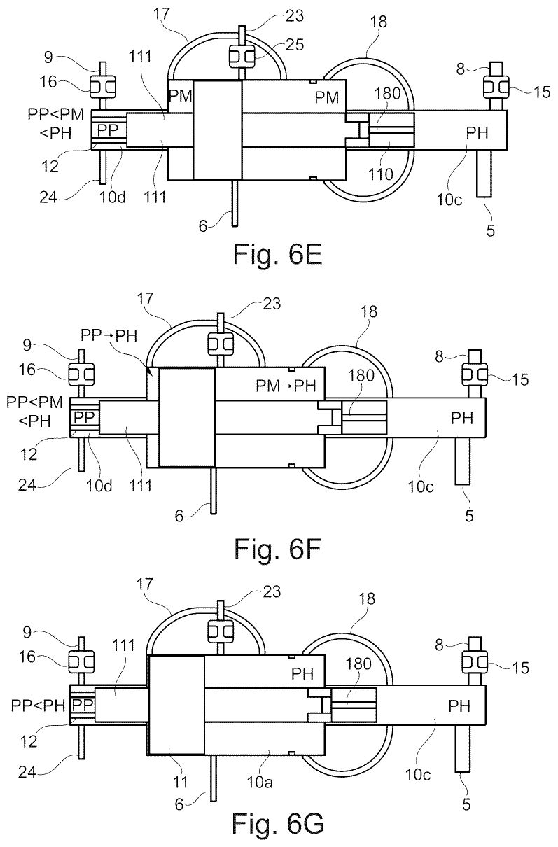

FIG. 7 shows a further exemplary embodiment of a valve unit according to the invention with detailed reproduction of components that are essential to functioning,

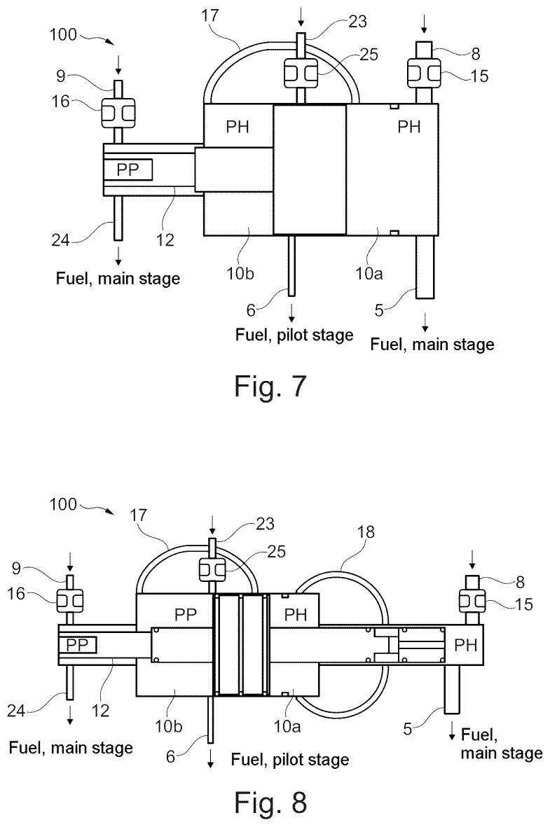

FIG. 8 shows a further embodiment variant of a valve unit according to the invention with detailed reproduction of valve components that are essential to functioning, and

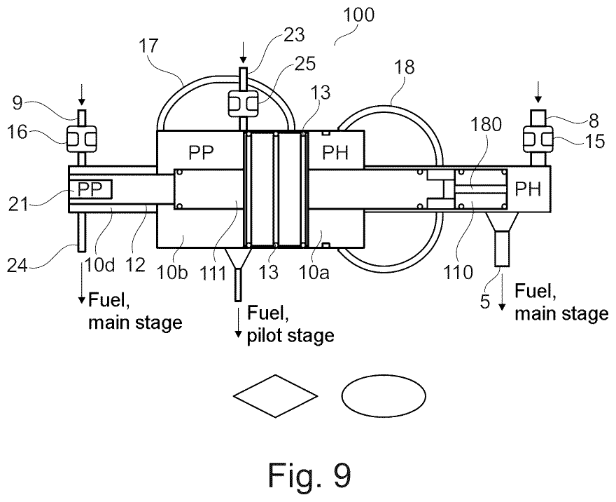

FIG. 9 shows a further exemplary embodiment of a valve unit according to the invention with detailed reproduction of valve components that are essential to functioning.

As FIG. 1 shows by way of example in sub-figures a), b) and c) and as is also described in the German Patent Application No. 10 2023 203 281.3 cited at the beginning, a fuel supply system for a combustion chamber 2 or for a fuel nozzle 3, for example of an aircraft engine, arranged on the input side thereof can be configured in different arrangements or installation positions with a fuel feed, arranged between a manifold 1 with an adjoining pre-chamber 4 (distribution chamber) and a downstream fuel nozzle 3, comprising a valve unit 100. For example, sub-figures a) and b) show two different orientations of a valve unit 100 in relation to a combustion chamber housing 7, wherein the valve unit 100 can be fitted, for example, on the combustion chamber housing 7 or the fuel nozzle 3 or at a small distance (radially) above or next to the combustion chamber housing 7 or the fuel nozzle 3 in, for example, a horizontal or vertical orientation with respect to the combustion chamber wall. In sub-figure c), the fuel feed is shown schematically in an arrangement in which a valve unit 100 serves to supply a plurality of fuel nozzles 3. The supply takes place in this case via a branch portion 14, in the present case a Y-piece, which divides the fuel flows evenly to in this case two fuel nozzles 3. An obturator 11 is arranged displaceably in the valve unit 100.

FIGS. 2A and 2B show a schematic illustration of valve units 100 according to the prior art, as is disclosed in the German Patent Application No. 10 2023 203 281.3 (not a prior publication) cited at the beginning, which are used in such a fuel feed of a fuel supply system for a combustion chamber 2, in the case of a simplified exemplary embodiment (FIG. 2A) and in the case of an exemplary embodiment illustrated in more detail (FIG. 2B). More detailed information about the incorporation and the functioning of such a valve unit 100 in conjunction with the fuel feed to a fuel nozzle 3 and adjoining combustion chamber 2 is likewise provided in the cited German Patent Application No. 10 2023 203 281.3, to which reference is additionally made here.

The valve unit 100 illustrated in FIG. 2A has a housing 101 in which an, in particular cylindrically shaped, valve space 10 is formed. The housing 101 is provided on the input side with a first inlet 8 for the connection of a first feed line, in particular main feed line, feeding a (first) fuel portion, and a second inlet 9 for the connection of a second feed line, in particular pilot feed line, feeding a (second) fuel portion, and is connected via these to the pre-chamber 4, to which fuel from a tank (not shown) is fed via the manifold 1. On the output side, the housing 101 is provided with a first outlet 5 for connecting to an output-side connection line, in particular main line, and with a second outlet 6 for connecting to an output-side second connection line, in particular pilot line. Via the first and second outlet 5, 6 and the first and second connection line, the fuel is fed to the relevant stages of the fuel nozzle 3, in particular a main stage or pilot stage. The second outlet 6 is offset axially inwardly (towards the middle of the valve space 10) compared with the second inlet 9, which is located closer to one end (in the present case the left-hand end) of the valve space 10, and so is not located in the same cross-sectional plane, perpendicular to the longitudinal axis, as the second inlet 9. In the present exemplary embodiment, the first outlet 5 is arranged approximately opposite the first inlet 8.

In contrast to the exemplary embodiment of the valve unit 100 that is shown (in a more basic manner) in FIG. 2A, the valve space 10 in the exemplary embodiment illustrated in more detail in FIG. 2B is extended at its two ends, in respective transitional planes located at right angles to the longitudinally extending valve space axis, in each case with an additional chamber, namely with a first additional chamber 10c on the side of the first chamber 10a (main chamber) and a second additional chamber 10d on the side of the second chamber 10b (pilot chamber), wherein the two additional chambers 10c, 10d have a smaller cross-sectional area than the first chamber 10a and the second chamber 10b, which have the same cross section as one another. The displaceable obturator 11 accordingly has a thicker portion that matches the cross section of the two chambers 10a and 10b and is delimited by two end faces which are perpendicular to the valve space axis and are each adjoined by a portion 110, 111 with a thinner cross section, which matches the cross section of the two associated additional chambers 10c and 10d, respectively. In the second additional chamber 10d, on the side of the second chamber 10b or pilot chamber, a restoring element 12, in particular spring, is supported or fastened at the end thereof, the opposite end of said restoring element supporting the obturator 11 on the end face of the thinner second portion 111. The relevant second inlet 9 for the fuel is arranged in the encircling wall of the second additional chamber 10d radially on one side, a pressure-regulating means 16 (restrictor) being arranged in or in the vicinity of said second inlet. The second outlet 6 is arranged in the second chamber 10b on the side opposite the second inlet 9, i.e. in a manner offset axially away from the end of the second additional chamber 10d or from the second inlet 9.

On the end face of the obturator 11 that faces the first additional chamber 10c, too, the thicker portion is adjoined by a thinner first portion 110, the cross section of which matches the cross section of the first additional chamber 10c and which is displaceably received therein. Formed in this thinner first portion 110, assigned to the first additional chamber 10c, of the obturator 11 is a channel arrangement 180, via which fuel can flow, by means of bridging via a bypass line 18, into the first chamber 10a (main chamber) in order to exert a relevant pressure on the facing end face of the thicker portion of the obturator 11 there. Furthermore, in the region of the second chamber 10b, too, a further bypass line 17 is provided, which is connected in the end region of the second chamber 10b on one side and, on the other side, is connected (in the state illustrated in FIG. 2B) in a region, covered laterally by the obturator 11, of the valve space 10 when the obturator 11 is brought into contact with a stop 22, provided in the valve space 10, by means of the restoring element 12 or the spring. Arranged radially in the end region of the first additional chamber 10c is the first inlet 8 for fuel and an associated pressure-regulating means 15 (restrictor), and, radially opposite said first inlet, optionally offset somewhat axially towards the first chamber 10a, the first outlet 5.

In the exemplary embodiment shown in FIG. 2B, a collecting chamber 19 having a holding element 20, in particular in the form of a magnet, is connected to the end of the first additional chamber 10c, said collecting chamber being able, in the case of failure, to receive any potentially accruing fragments of components in the interior of the valve unit 100, such that they do not additionally disrupt the functioning. Inserted into the second additional chamber 10d, in addition to the restoring element 12 in the form of the spring, is an additional elastic element 21, in particular an additional support spring, which is shorter than the restoring element 12, wherein, in the event of abutment of the obturator 11 in the relevant displacement position, an additional, increased supporting force is generated. A corresponding or similar function can be created by means of a spring with a non-linear characteristic.

The additional elastic element 21, in particular in the form of the shorter support spring, or the spring with the non-linear spring characteristic, in the second additional chamber 10d (in this case the more rigid part) replaces a stop on the relevant side (the left-hand side in the drawing) for the (main) spring or the softer part of the spring under high-load conditions with PH>>PP (pressure in the first or main chamber very much higher than the pressure in the second or pilot chamber), since, in this situation, the restoring element 12 or the relevant spring is not fully compressed in order to make space for further piston displacement in an emergency scenario. During normal operation, the support spring or the harder part of the spring thus prevents accidental opening up, caused by fluctuations in the balance of forces, of the second outlet 6 or of the pilot line by the obturator 11 (for instance as a result of centrifugal forces during a flight or fluctuations in the fuel pressure). In this case, too, a stopper or stop 22 can be provided in the valve space 10, said stopper or stop marking the zero position of the obturator 11 or piston with the restoring element 12 relaxed.

More details about the purpose of subdividing the valve space 10 or the first and/or second chamber 10a, 10b into multiple portions with different cross sections are provided in the cited German Patent Application No. 10 2023 203 281.3, which is not a prior publication, to which reference is additionally made here. Reference is also made to the German Patent Application No. 10 2023 203 281.3 for a more detailed explanation as to how the lines of the fuel feed and pressure-regulating means 15, 16 (restrictors) arranged therein affect the resulting pressure situations in particular in the valve unit 100, too.

As mentioned at the beginning, the obturator 11 mounted displaceably in the valve space 10 can, depending on the operating state of the combustion chamber 2 or of the engine, take up a position in which it closes the second outlet 6, with the result that, via the latter, the feed of fuel to the fuel nozzle, in particular the pilot stage, is immediately prevented, owing to an inevitable effect in incompressible, liquid fuels. As a result, the pressure difference between the first and the second chamber 10a, 10b, or pilot and main chamber, at higher operating points cannot increase further, and so the movable obturator 11 remains in a metastable and poorly predictable position. During operation, it is therefore possible for pressure fluctuations between the pilot and main chamber to result in the cylinder moving back and forth precisely at the position at which the second outlet 6 or pilot outlet is closed, such that the relevant outlet 6 can repeatedly open and fuel is briefly passed to the relevant stage, in the present case the pilot stage, of the fuel nozzle 3. Quiet, low-emission and predictable operation of the combustion chamber 2 cannot be ensured in this way.

In order to overcome this drawback, the valve unit 100, in contrast to the embodiment set out in the cited German Patent Application No. 10 2023 203 281.3, is provided with a further inlet 23 and a further outlet 24, as shown in FIGS. 3, 4 and 6A to 9. Otherwise, the construction illustrated in the Patent Application No. 10 2023 203 281.3 forms the basis.

The basic functioning of the valve unit 100 according to the invention that is designed in this way, in conjunction with the fuel feed, is explained in principle in the following text with reference to FIG. 3 with sub-figures a), b) and c) and FIG. 4 with sub-figures a) and b).

As a result of the pressure difference DP=PH−PP in the first and second chamber 10A and 10B (or in the main chamber and pilot chamber), a pressure force intended to move the obturator 11 acts on the obturator 11. This is counteracted by the spring force of the restoring element 12. As a result of the pressure difference DP changing, the difference between the pressure force and spring force is changed. When this differs from zero, the obturator 11 is correspondingly displaced until equilibrium of the forces is re- established and the obturator 11 takes up a new position. Depending on the position of the obturator 11, the second outlet 6 to the corresponding stage, in particular pilot stage, of the fuel nozzle 3 can be closed and thus the fuel flow into the drain, in particular pilot line, connected to the second outlet 6 can be interrupted. In order that the necessary higher pressure level than in the first chamber 10a (main chamber) continues to be maintained in the second chamber 10b (pilot chamber) following closure of the second outlet 6 or pilot line, according to the invention the further outlet 24 with a connection line connected thereto is present at the second chamber 10b. The further outlet 24 is offset axially with respect to the second outlet 6 in the direction towards the end of the second chamber 10b. The connection line from the further outlet 24 is connected such that it leads into the main stage of the fuel nozzle 3 or of the burner. In particular, the further outlet 24 with the connected connection line is formed as far as the outlet from the fuel nozzle 3 such that, therein, (virtually) the pressure loss is induced as a flow via the second outlet 6 or the relevant pilot line. Therefore, where necessary, the connection line or further main line connected to the further outlet 24 is guided only a very long way downstream into the connection line or main line connected to the first outlet 5, optionally only downstream of any trim orifices in the connection line or main line, connected to the first outlet 5, between the valve unit 100 and an outlet out of the fuel nozzle.

In order to set the mass flow through the second chamber 10b or pilot chamber such that, at the transition from an open to a closed outlet 6 (and vice versa) there is no (upward or downward) jump in the pressure, when the second outlet 6 is opened or closed, the mass flow into the chamber 10b is also adjusted. Therefore, a further inlet 23 is arranged in the same axial position as the second outlet 6, for example diametrically opposite. The feed line connected to the further inlet 23 is equipped with a pressure-regulating means 25 (restrictor) (cf. FIG. 6) which is dimensioned such that, in the case of an open second outlet 6, fuel with the same pressure loss enters the second chamber 10B from the pre-chamber 4 or the manifold 1 via the second inlet 9 and the further inlet 23 or via the feed lines connected thereto. Furthermore, the feed line connected to the further inlet 23 and a pressure-regulating means 25 (restrictor) optionally arranged therein are dimensioned such that they provide exactly the mass flow requirement for the relevant stage (pilot stage) of the fuel nozzle 3 or of the burner in the case of an open second outlet 6. If the second outlet 6 is closed, fuel only enters the second chamber 10b via the second inlet 9 and a pressure-regulating means 15 (restrictor) arranged therein and passes out via the further outlet 24, which is connected to the connection line of the main stage. The feed line to the second inlet 9, the pressure-regulating means 15 and the connection line at the further outlet 24 are dimensioned such that, with the omission (or addition) of the mass flow path from the feed line into the second outlet 6 via the further inlet 23, there is no sudden change in pressure in the second chamber 10b.

Sub-figure a) in FIG. 3 shows the state without pressure or with pressure equilibrium in the first and second chamber 10a, 10b (main chamber and pilot chamber) of the valve unit 100, or PP=PH. In other words, the combustion chamber 2 is in a non-operational state, or the relevant engine is switched off, and the restoring element 12 in the form of the spring is in its rest position (relaxed state), i.e. the spring force is zero. The second outlet 6 and the further inlet 23 are open.

Sub-figure b) in FIG. 3 shows a state in which the burner or the engine is in operation. The pressure increases and the pressure in the first chamber 10a (main chamber) is greater than the pressure in the second chamber 10b (pilot chamber), as, for example, when the engine is idling. The obturator 11 moves in the direction of the second chamber 10a, the restoring element 12 is compressed, and the second outlet 6 and the further inlet 23 are open.

Sub-figure c) in FIG. 3 shows the state in which the pressure increases further, i.e. the pressure in the first chamber 10a (main chamber) is very much higher than the pressure in the second chamber 10b (pilot chamber) PH>>PP, as, for example, in the operating state of a cruise or when the aircraft is taking off. The second outlet 6 and the further inlet 23, located in the same axial position, are covered by the obturator 11, wherein the arrangement of the sealing means 13 on the obturator 11 has the result that the second outlet 6 and the opposite further inlet 23 are closed tightly by the lateral surface of the obturator 11.

Sub-figure a) in FIG. 4 shows a state in which the combustion chamber 2 or the engine is in operation, wherein the pressure in the first chamber 10a (main chamber) is higher than the pressure in the second chamber 10b (pilot chamber), i.e. PH>PP or PH>>PP. The restoring element 12 or the spring fails and is therefore completely compressed by loss of the spring force. The obturator 11 moves further into the second chamber 10b, such that the second outlet 6 and the opposite inlet 23 are opened up again. In this way, reliable operation of the combustion chamber or of the engine is ensured under all circumstances, since both the connection line is supplied with fuel via the second outlet 6 and the connection line is supplied with fuel via the first outlet 5, and both the pilot and the main line are supplied with fuel.

Sub-figure b) in FIG. 4 shows a state in which the restoring element 12 or the spring is broken. The operation of the combustion chamber 2 or of the engine is switched off, and the obturator 11 can move freely and, depending on the installation situation or the position of the valve unit 100 in the fuel supply system or the engine, can take up a position in the valve space 10. In this regard, there is a further safety position on the side of the first chamber 10a (main chamber), into which the obturator 11 is pushed by switching on a fuel pump and building up pressure P0 (in the manifold) and thus PH and PP, such that here too, under all circumstances, the second outlet 6 and the first outlet 5, or the pilot line and the main line, are always free. In this state, the second chamber 10b extends over a volume of the valve space 10, which, in normal operation, would actually be reserved for the first chamber 10a (main chamber). The first chamber 10a (main chamber) is no longer supplied with fuel, and the second chamber 10b (pilot chamber) now comprises both the first inlet 8 and the second inlet 9 and also the first outlet 5 and the second outlet 6.

As explained above with reference to FIG. 1, the installation position of the valve unit 100 is irrelevant, and it may, for example, be fitted directly (radially) above or next to the fuel nozzle 3, and it is also possible for the valve unit 100 to supply multiple fuel nozzles 3, for example via a Y-piece which divides the fuel flows evenly to in this case two fuel nozzles.

FIG. 5 shows, in a diagram, the relationship between the different pressures P0 (in the manifold 1), PH (in the first chamber 10a, main chamber), PP (pressure in the second chamber 10b, pilot chamber), Pp (pressure downstream of the second chamber 10b), Ph (pressure upstream of the first chamber 10a) and P30 (pressure at the combustion chamber inlet) in the operating range of an engine, in particular between idle and take-off.

FIGS. 6A to 6G show an exemplary embodiment of a valve unit 100 according to the invention in a more detailed illustration with indicated operating states and existing pressure states.

FIG. 6A shows an embodiment with an additional collecting chamber 19, similar to FIG. 2B, but with the further inlet 23, in the feed line of which a further pressure- regulating means 25 is arranged, and the further outlet 24, which leads to the main stage of the burner or of the fuel nozzle 3, in particular with connection to the connection line connected to the first outlet 5. Via the collecting chamber 19, it is possible, in the case of spring breakage, for fragments to be received which can be retained by means of a magnet 20 arranged at the end of the collecting chamber 19. In this embodiment, too, the fixed end wall of the first chamber 10a and of the second chamber 10b is adjoined by a first additional chamber 10c and a second additional chamber 10d, respectively, with a cross section that is reduced compared with the first and the second chamber 10a, 10b (main chamber and pilot chamber) but is constant. The obturator 11 that is mounted displaceably in the valve space 10 and separates the first chamber 10a from the second chamber 10b in a fluid-tight manner by means of encircling sealing elements 13 has portions, namely a first portion 110 and a second portion 111, that protrude from the end face and match the cross section of the first and second additional chamber 10c, 10d, respectively. Furthermore, a bypass line 17 that connects the first chamber 10a and the second chamber 10b in certain operating states and a bypass line 18 that connects the first chamber 10a to the first additional chamber 10c are arranged next to the valve housing 101. The obturator 11 is supported, on its end side facing the second additional chamber 10d, by means of the restoring element 12, against the inner end side, facing away from this end side of the obturator 11, of the second additional chamber 10d by means of the restoring element 12 in the form of a spring. In the present case, the restoring element 12 is supplemented by an elastic element 21 in the form of a support spring, which is configured and arranged such that it supports the restoring element 12 under high-load conditions when the obturator 11 travels a long way onto the side of the second chamber 10b, the left-hand side in the figure. The elastic element 21 replaces a stop on the side of the second chamber 10b or second additional chamber 10d for the restoring element 12 under high-load conditions, wherein PH>>PP, since in this situation, the restoring element 12, in particular in the form of the spring, is not fully compressed, in order to make space for the further piston displacement in an emergency scenario. In regular operation or normal operation, the elastic element 21 in the form of the support spring thus prevents accidental opening up, caused by fluctuations in the balance of forces on the obturator 11, of the second outlet 6 (for instance as a result of centrifugal forces during a flight or fluctuations in the fuel pressure). In the valve space 10, a stop 22 or stopper can also be provided, which marks the zero position of the obturator 11 with the restoring element 12 relaxed.

As discussed, the obturator 11 may consist of multiple portions with different diameters, i.e. from, for example, three portions with three or two different diameters, as in the exemplary embodiment according to FIGS. 6A to 6G and FIGS. 8 and 9. In the exemplary embodiment according to FIG. 7, compared with these figures, the first additional chamber 10c and accordingly the first portion 110 have been omitted, and so the obturator 11 has been simplified to such an extent that it has only two portions with different diameters.

The purpose of dividing the valve space 10 and accordingly the obturator 11 into portions with different diameters or cross sections is that the surface load on the end faces of the obturator 11 as a result of the pressure difference DP=PH-PP can be made dependent on the position of the obturator 11. As a result, a compact valve unit 100 can be realized, which can work over a very broad pressure range. In order to achieve this functionality, the correspondingly arranged bypass lines 17 and 18, and in the case of the embodiment according to FIG. 7 only the bypass line 17, are present, which ensure that, given particular positions of the obturator 11, the end faces of the thicker piston portion have the same pressure on both sides and thus drop out of the balance of forces. This functioning as such is also mentioned in the cited German Patent Application No. 10 2023 203 281.3 and will be explained in even more detail in the following text in conjunction with the features that differ from this prior application.

FIG. 6A shows the operating state analogously to FIG. 3A, that is to say the rest position or nominal position, wherein the fuel supply of the relevant stage, in particular pilot stage, takes place via the second chamber 10b and of the first stage, or main stage, via the first chamber 10a under operating conditions starting from ignition of the combustion chamber down to the low-load range. In this case, the pressure difference DP=PH−PP is zero or so small that the obturator 11 can be held just by the restoring element 12 in the stop position of the first chamber 10a, or the right-hand stop position in the figure (in contact with the stop 22). The restoring element 12 optionally exhibits a preload in the nominal position. The obturator 11 is subjected, on both sides, over its entire area (i.e. the end faces of the thin and thick obturator portions), to the pressure PP (in the second chamber 10b, pilot chamber) and the pressure PH (in the first chamber 10a, main chamber). On the side of the first chamber 10a (the right-hand side in the figure), the fuel has to have the pressure PH on the side of the first chamber 10a (relevant thick portion of the cylinder space 10). To this end, fuel passes into the thinner, first portion 110 of the obturator through the local end face, and then through the internal channels 180 arranged therein and subsequently through the bypass line 18. The bypass line 18 is present, for example, axially symmetrically at the top and bottom (optionally also in further opposite spatial directions) in order to prevent tilting of the obturator 11 as a result of radial loads. On the side of the second chamber 10b of the valve space 10, i.e. in the present case on the left-hand side, the local thin second portion 111 of the obturator 11 does not close the transition between the local (left-hand) second additional chamber 10d and the second chamber 10b, and so both chambers 10b and 10d are connected hydraulically together and exhibit the same pressure.

FIG. 6B shows a state in which the second outlet 6 (to the pilot stage) and the opposite inlet 23, arranged in the same axial position, are closed. The operating state of the combustion chamber 2 or of the engine is increased beyond the low-load range. As a result of the increasing absolute pressure difference between the second chamber 10b (pilot chamber) and the first chamber 10a (main chamber), the obturator 11 has been displaced counter to the restoring element 12 or the spring. Under this condition, the lateral surface of the thick portion of the obturator 11 closes precisely the second outlet 6 of the second chamber 10b and the opposite inlet 23, located in the same axial position, and thus deactivates the fuel supply of the relevant stage (in particular pilot stage) via the second chamber 10b. Otherwise, the situation corresponds to that in FIG. 6A.

FIG. 6C shows a situation in which the central, thick portion of the obturator 11 and the central region of the valve space 10 are functionally decoupled from the first and second chamber 10a, 10b, in order to reduce displacements in medium-and high-load operation of the combustion chamber 2 or of the engine. The second outlet 6 (pilot outlet) is closed. Since the absolute pressure difference at operating points above the low-load range increases significantly, the position of the obturator 11 can no longer be regulated to a meaningful degree just by the spring force of the restoring element 12 (this would result in an extremely long valve unit). Therefore, the surface load on the obturator 11 is reduced. To this end, the central region of the valve space 10 is decoupled from the first and second chamber 10a, 10b in that the internal channels of the channel arrangement 180 are displaced with respect to the inlet of the bypass line 18 such that the latter is closed. At the same time, the second and first chamber 10b, 10a, or the left-hand and right-hand side of the valve space 10, are connected together by the other bypass line 17, since the lateral surface of the thick central portion of the obturator 11 now opens the latter up on the side of the first chamber 10a (right-hand side of the valve space 10). The second chamber 10b (left-hand side of the valve space 10), by contrast, is separated from the second additional chamber 10d since the second portion 111 of the obturator 11 is now shifted into the transitional plane between the second chamber 10a and the second additional chamber 10d. In the central region of the valve space 10, or of the first and second chamber 10a, 10b, a medium pressure PM is now established by the connection of the second chamber 10b and the first chamber 10a. If the obturator 11 is displaced even further in the direction of the second additional chamber 10d (to the left in the figure), fuel is moved via the bypass line 17 from the second chamber 10b into the first chamber 10a (from the left-hand side into the right-hand side of the central region of the valve space 10 in the figure). Thus, the fuel now enclosed in the second chamber 10b and the first chamber 10a (on both sides of the central region of the valve space 10) does not prevent the movement of the obturator 11.

FIG. 6D shows the situation in which the obturator 11 comes into contact with the elastic element 21 (support spring) during high-load operation. The second outlet 6 (pilot outlet) and the opposite further inlet 23 in the same axial position are still closed. The remaining free volume of the second chamber 10b (pilot chamber) is fed via the inlet 9. The fuel flows out via the further outlet 24 into the main stage, connected thereto via the relevant connection, of the fuel nozzle 3 or of the burner. In high-load operation, the obturator 11 is close to its end position for normal operation. The situation is similar to the one in FIG. 6G, except that now the end face of the second portion 111 of the obturator (left-hand portion) rests on the elastic element 21 (support spring). The purpose of the elastic element 21 is to damp further displacements of the obturator 11. The elastic element 21 in practice replaces a stop, a left-hand stop in the figure, arranged on the side of the second chamber 10b or second additional chamber 10b, in order to allow the error scenarios illustrated in the following FIGS. 6F and 6G and described further below. The second outlet 6 (pilot outlet) is still closed by the lateral surface of the central, thick portion of the obturator 11, but, in the meantime, by its side adjacent to the first chamber 10a, its right-hand side in the figure.

FIG. 6E shows the valve unit 100 with the obturator 11 in its end position under starting full load. The second outlet 6 (pilot outlet) and the further inlet 23 located in the same axial position are still closed. The situation is almost identical to FIG. 6D. The main difference is that the elastic element 21 (support spring), under starting full load, is lightly loaded on account of the now maximum pressure difference between PH and PP.

FIG. 6F shows the situation in the case of failure of the restoring element 12 (spring under low-load conditions). The second stage or pilot stage is fed via the second outlet 6, which is now located in the region of the first chamber 10a (main chamber). The restoring element 12 is broken under the lowest condition, under which, during normal operation, the second outlet 6 (pilot outlet) and the further inlet 23, located axially at the same position, are closed. Since the restoring element 12 no now longer supports the force of the pressure PP in the second chamber 10b (pilot chamber), the obturator 11 is pushed to such an extent in the direction of the second chamber, to the left in the figure, by the pressure force of the pressure PH in the first chamber 10a (main chamber) that the second outlet 6 and the further inlet 23, located at the same axial position, are opened up again, but on the side of the first chamber 10a, the right-hand side of the valve space 10 in the figure. Should the elastic element 21 (support spring) still be intact, its spring constant alone is not sufficient to keep the obturator 11 in a position to close the second outlet 6 and the further inlet 23 located at the same axial position. In this emergency scenario, a failing valve unit 100 is intended to feed the second stage or pilot stage permanently with fuel in order in this way to ensure the supply of the fuel nozzle 3 and combustion in all situations. The entire central region of the valve space 10 is now subjected to the pressure PH in the first chamber 10a (main chamber), since the obturator 11 now does not block either of the bypass lines 17 and 18. The internal channels of the channel arrangement 180 in the first portion 110 of the obturator 11 also now connect the first additional chamber 10c to the first chamber 10a. The end faces of the central, thick portion of the obturator 11 therefore have no influence on the position of the obturator 11.

FIG. 6G shows the situation in the case of failure of the restoring element 12 (spring) under high-load conditions up to and including full load (starting, take-off). The second stage or pilot stage is fed via the first chamber 10a (main chamber). The scenario is similar to FIG. 6F, only that at high load, the pressure PH in the first chamber 10a (main chamber) is so high that the obturator 11 is pushed to such an extent in the direction of the second chamber 10b, to the left in the figure, that it comes into abutment in within the central region of the valve space 10.

FIG. 7 shows an exemplary embodiment, simplified compared with the embodiment according to FIGS. 6A to 6G, of a valve unit 100, wherein, on the side of the first chamber 10a or on the right-hand side of the figure, the first, thin portion 110 of the obturator 11 and the first additional chamber 10c have been omitted, and the bypass line 18 is also missing. Otherwise, the functioning is analogous to the above description in relation to the embodiment according to FIGS. 6A to 6G. If the obturator 11, starting from a particular pressure difference DP=PH−PP, has been displaced in the direction of the second chamber 10b, or to the left, it blocks the second outlet 6 (pilot outlet) and the further inlet 23 located at the same axial height. If the obturator 11 has been displaced even further in the direction of the second chamber 10b, or to the left, the thin second portion 111 located there separates the second chamber 10b from the following second additional chamber 10d and the bypass line 17 is opened up, as is apparent from FIG. 7. As a result, only the pressure PH as prevails in the first chamber 10a or the main chamber likewise prevails in the second chamber 10b. Consequently, in the balance of forces of the pressure forces on the obturator 11, the portion of the end face, facing the first chamber 10a, or right-hand end face, of the obturator 11, which goes beyond the end face of the second, narrow portion 111, is eliminated. The corresponding effect is also brought about in the more complex embodiment according to FIGS. 6A to 6G, only that the central region of the valve space 10 is subjected there to a quite low intermediate pressure PM, while, in the embodiment according to FIG. 7, the pressure PH prevails in the first chamber or the central region of the valve space 10. This means that, via the bypass line 17, upon further displacement of the obturator 11, fuel is also moved with the pressure PH (rather than PM as in the embodiment according to FIGS. 6A to 6G). This is a drawback of the simpler configuration according to FIG. 7: the movement of fuel at high pressure PH in the bypass line 17 means a higher friction loss than in the case of the pressure PM, and consequently the obturator 11 is displaced more slowly to its next position when the pressure P0 changes. This may be a drawback in particular in aircraft engines, in which, for safety reasons, rapid load changes are necessary (for example during an aborted start or rapid fuel drop, go-around during aborted landing and resultant rapid fuel increase). By contrast, the simpler and more compact design are advantageous.

According to a further configuration variant shown in FIG. 8, the valve unit 100 is designed such that, over a particular operating range (which is passed through in a stationary or transient manner), both the fuel line leading to the second stage or pilot stage and the fuel line leading to the first or main stage, or the relevant second and first outlet 6, 5, are supplied with fuel. This takes place primarily in order to make the transition from one fuel supply line to the other smooth. By way of example, FIG. 8 shows the obturator 11 in a position in which the second outlet 6 or pilot outlet and the further inlet 23 located at the same axial height have been completely opened up and the first outlet 5 or the relevant main line has been largely opened up.

An embodiment variant with further details is shown in FIG. 9. This figure shows two further configuration options for influencing the transition from one fuel supply to the other. Firstly, the transitions from the valve space 10 into the fuel lines or the first and the second outlet 5, 6 are funnel-shaped. This allows the operating range (or the range of the position of the obturator 11) in which both fuel lines are supplied with fuel to be enlarged in a desired manner. Secondly, the transitions to the outlets can be provided with cross sections which additionally influence, in a defined manner, the division of the fuel flow between the second stage or pilot stage and the first stage or main stage during the transitional phase. These cross sections may be, for example, triangular, diamond-shaped or oval.

In order to minimize or eliminate desired fuel flows between the inner wall of the housing 101 of the valve unit 100 and the lateral surface of the obturator 11, the obturator 11 may be provided, at various positions, with sealing means 13, for example with O-rings inserted into grooves. In this regard, the figures show exemplary possible configurations.

1-23. (canceled)

24. A valve unit having an, in particular cylindrical, valve space which is arranged in a housing and which is subdivided, by means of an obturator arranged adjustably and in a fluid-tight manner in the valve space, into two chambers, a first chamber and a second chamber, that are separated from one another in a fluid-tight manner and through which fuel flows or is able to flow, wherein
the valve space has a first inlet for feeding a first fuel portion, in particular main fuel, and a second inlet for feeding a second fuel portion, in particular pilot fuel,
the valve space has a first outlet, in particular for supplying fuel to an engine main stage, and a second outlet, in particular for supplying fuel to an engine pilot stage,
the valve unit has an elastic restoring element, in particular a spring arrangement, which is arranged in one of the chambers, in particular in the second chamber and is coupled in a force-transmitting manner to the obturator, and
the valve unit is configured such that an adjustment force for positioning the obturator within the valve space is generated by a restoring force of the restoring element interacting with a pressure difference between the chambers, which results between the fuel pressures within the chambers, with the result that the obturator is adjustable into a closing position blocking the second outlet,
wherein the second chamber is provided with a further inlet for feeding a further fuel portion and with a further outlet, via which fuel is able to be discharged from the second chamber and which remains open when the obturator is in the closing position closing the second outlet, and
in that the further outlet is designed to supply the engine main stage with fuel, in particular by connection to the first outlet in the downstream region thereof.

25. The valve unit according to claim 24, wherein the further inlet is arranged at the second chamber axially in a corresponding position to the second outlet, such that it is likewise blocked by the obturator when the latter is in the closing position closing the second outlet.

26. The valve unit according to claim 24, wherein the valve unit is assigned at least one pressure-regulating means which, to set a pressure ratio between the first chamber and the second chamber, is arranged preferably upstream of the valve space in order to generate a defined fuel ratio between the first fuel portion and second fuel portion, wherein preferably a lower pressure is generated or able to be generated in the second chamber than in the first chamber.

27. The valve unit according to claim 26, wherein both the first inlet and the second inlet and/or further inlet are assigned a pressure-regulating means, wherein, in the event that the second inlet and the further inlet are assigned a pressure-regulating means, either the second inlet and the further inlet are each assigned a pressure-regulating means or both of these inlets are assigned a common pressure-regulating means via a Y-connection.

28. The valve unit according to claim 26, wherein the at least one pressure- regulating means is in the form of a passive flow element that is not adjustable during operation, in particular having a narrowing of the flow cross section.

29. The valve unit according to claim 24, wherein the valve unit can take up a regular configuration and/or an error configuration, wherein
in the regular configuration, the obturator is arranged within the valve space such that, during operation in a first adjustment mode, the first inlet, and not the second inlet, is fluidically connected to the first outlet by the first chamber, and/or such that the second inlet and the further inlet, and not the first inlet, are fluidically connected to the second outlet and the further outlet by the second chamber, and in a second adjustment mode, at least the second outlet is blocked in a manner preventing flow-through by means of the obturator, such that flow does not take place through the second outlet, but flow continues to take place through the second chamber via the further outlet, and/or
in the error configuration, the obturator is arranged next to the outlets within the valve space such that, during operation, the first and the second outlet are fluidically connected to at least the same inlet for fuel supply, and the further outlet is fluidically connected at least to the second inlet,
in that the restoring element is designed such that, in the regular configuration, the first adjustment mode is set without a pressure difference, for example with the engine switched off, and/or with a small pressure difference between the chambers, for example in a low-load range of an engine, and/or
the second adjustment mode is set with a greater pressure difference than the small pressure difference, for example in a medium-and/or high-load range,
in that in the error configuration, in a first error position, the obturator is positioned further in the direction of the restoring element compared with the regular configuration, in particular with a reduction in size of the second chamber, and/or
in a second error position, the obturator is positioned further in the direction of an opposite end of the valve space from the restoring element compared with the regular configuration, in particular with a reduction in size of the first chamber, such that the first inlet is fluidically connected to the second chamber.

30. The valve unit according to claim 24, wherein the valve space is formed in an elongate, in particular cylindrical, manner and/or has, along its length, a constant cross section or portions with different cross sections, wherein the cross section is constant within the portions,
in that the obturator is arranged in the valve space so as to be axially displaceable in the longitudinal direction, wherein the obturator has in particular a corresponding cross section to the valve space in order to be in fluid-tight contact with the inner walls of the valve space, preferably with at least one sealing means arranged in between, and
in that within the valve space, in particular in the first chamber, at least one stop element is arranged, which limits the movement of the obturator by the restoring element at a zero position.

31. The valve unit according to claim 24, wherein a collecting chamber for receiving fragments of elements present in the valve space, in particular of the obturator and/or of the restoring element, is arranged next to the valve space, in particular next to the chamber that does not contain the restoring element, wherein a holding element, in particular a magnet, is arranged in the collecting chamber.

32. The valve unit according to claim 24, wherein, in addition to the restoring element, a second elastic element, in particular a support spring, is arranged on the side of the restoring element, said second elastic element being shorter than the restoring element and being designed to cooperate with the restoring element, in particular under high-load conditions, and having, for example, lower elasticity than the restoring element in order to support the restoring force thereof, or
in that a spring having a restoring force that is not linear along its spring travel is used as restoring element.

33. The valve unit according to claim 24, wherein the valve space has portions with different cross sections, wherein, in the valve space, a first additional chamber with a smaller cross section adjoining the first chamber in an axial direction is formed on the side of the first chamber and/or a second additional chamber of smaller cross section adjoining in the opposite axial direction is formed on the side of the second chamber,
in that the obturator, which is displaceable in the valve space, has portions with a thicker and a thinner cross section corresponding to the first and second chamber and to the first and/or second additional chamber,
in that when the first and second additional chamber exist, the relevant first and second inlet are arranged at the respective additional chamber and the further inlet is arranged at the second chamber, the first outlet is arranged at the first additional chamber, the second outlet is arranged at the second chamber and the further outlet is arranged at the second additional chamber, and
in that in a configuration without the first additional chamber, the first inlet and the first outlet are arranged at the first chamber, the second inlet is arranged at the second additional chamber, the further inlet is arranged at the second chamber, the second outlet is arranged at the second chamber and the further outlet is arranged at the second additional chamber.

34. The valve unit according to claim 33, wherein, parallel to the valve space, there is at least one bypass line, which is/are arranged such that, with particular positions of the obturator in the valve space, the two end faces of the thicker portion are subject to the same pressure on both sides, and
in that when the first additional chamber and the corresponding portion of thinner cross section of the obturator exist, a channel arrangement is formed in this portion in order to fluidically connect an inlet region of the first additional chamber to the first chamber via the associated bypass line.

35. The valve unit according to claim 24, wherein at least one of the transitions from the valve space into the first or the second outlet is narrowed in a funnel shape towards an adjoining line portion, or has a cross section that influences the division of the fuel flow between the pilot fuel and the main fuel in a defined manner.

36. A fuel supply system for supplying a gas turbine arrangement, in particular of an aircraft, with fuel, comprising a valve unit according to claim 24, wherein the further outlet is fluidically connected on the downstream side, via a connecting line, to a connection line leading from the first outlet to the main stage, and wherein
an individual valve unit for supplying one or more main stages and/or one or more pilot stages with fuel is formed, wherein, downstream of the valve unit, a branch portion is arranged in a main line and/or in a pilot line, optionally in each.

37. A gas turbine arrangement having a combustion chamber arrangement and a fuel supply system comprising at least one valve unit according to claim 24 and a turbine arrangement.

38. A method for operating a fuel supply system of a gas turbine arrangement, in particular of an aircraft, in which a valve unit according to claim 24 is used.
